(19) United States
(12) Patent Application Publication
(10) Pub. No.: US 2023/0375138 A1
(43) Pub. Date: Nov. 23, 2023

(54) LIQUEFIED GAS SYSTEM WITH BOIL-OFF CAPTURE

(71) Applicant: NuMat Technologies, Inc., Skokie, IL (US)

(72) Inventors: Timothy C. Wang, Buffalo Grove, IL (US); William Morris, Chicago, IL (US); John Paul Siegfried, Chicago, IL (US); Jackson J Du, Des Plaines, IL (US); Ross James Verploegh, Buffalo Grove, IL (US)

(73) Assignee: NuMat Technologies, Inc., Skokie, IL (US)

(21) Appl. No.: 18/199,810

(22) Filed: May 19, 2023

Related U.S. Application Data
(60) Provisional application No. 63/344,447, filed on May 20, 2022.

(51) Int. Cl. F17C 11/00; B01D 53/04; H01M 8/04082; B01J 20/34; B01J 20/22

(52) U.S. Cl. CPC F17C 11/005; B01D 53/04; H01M 8/04216; B01J 20/34; B01J 20/226; F17C 2221/012; F17C 2223/0123; F17C 2270/01; B01D 2253/204; B01D 2257/108; B01D 2259/40088; B01D 2253/311; B01D 2259/4525; B01D 2259/4566

(57) ABSTRACT

A liquefied gas system for capturing boil-off gas and reversibly adsorbing the boil-off gas on an adsorbent for later desorption and use comprises a first vessel for storing liquefied gas; a means for delivering gas from the first vessel to a system endpoint; a second vessel for storing boil-off gas emitted from the first vessel, the second vessel containing at least one adsorbent; a means for delivering boil-off gas from the first vessel to the second vessel, whereby the boil-off gas is reversibly stored on the at least one adsorbent; and a means for delivering the stored boil-off gas from the second vessel to the system endpoint. Also disclosed is a method of capturing boil-off gas from a liquefied gas system, wherein the captured boil-off gas is captured on an adsorbent for further use in the system. In one embodiment of the system and the method, the liquefied gas is liquid hydrogen, and the captured boil-off gas is used to power a hydrogen fuel cell.

### CROSS-REFERENCE TO RELATED APPLICATIONS

This application claims priority from U.S. Provisional Application No. 63/444,447, filed May 20, 2022 which is incorporated herein in its entirety.

### STATEMENT REGARDING FEDERALLY SPONSORED RESEARCH OR DEVELOPMENT

This invention was made with U.S. Government support under Agreement No. DE-SC0021910 awarded by the Department of Energy. The Government has certain rights in the invention.

### FIELD OF THE INVENTION

This disclosure relates to a liquefied gas system in which boil-off gas is captured and reversibly stored on an adsorbent to be desorbed for later use. This disclosure further relates to a liquefied gas system in which boil-off gas is captured and reversibly stored on an adsorbent to be desorbed for later use, wherein the system can be adapted for use on a transportation vehicle, with a building, or with industrial equipment.

### BACKGROUND OF THE INVENTION

This disclosure relates to a liquefied gas system in which boil-off gas emitted from a vessel containing a low boiling point gas is captured and reversibly stored on an adsorbent to be desorbed for later use. The system described herein is particularly suitable for use with liquefied hydrogen; however, the use of the system is not limited to liquefied hydrogen, and other liquefied gases can be used in the boil-off capture system as described herein. The system will be described herein with respect to liquefied hydrogen for ease of description and understanding, it being understood that the use of the system is not so limited.

There has been growing interest in the use of renewable energy sources as fuels in the transportation industry and other industrial applications. One area of interest is electric vehicles which use rechargeable battery systems. While battery-based systems can be well suited for smaller vehicles such as passenger cars, they can present significant challenges for larger vehicles or fleets of vehicles, such as freight trucks. The slow recharging rate and low energy density of current lithium battery systems preclude their practical use in heavy-duty vehicles, marine vessels, trains, aircraft, and industrial equipment for farming, mining, and construction. For example, it has been found that a lithium-ion battery-powered truck with 900 miles of range will have a maximum payload of only 4,000 kg, with the gross weight of an empty truck exceeding eight times the payload.

A powertrain that uses a hydrogen fuel cell is an alternative for overcoming the drawbacks of lithium-ion batteries. As the lightest element on the periodic table, hydrogen has the highest gravimetric energy content of all fuels. Therefore, the onboard energy storage based on hydrogen can be significantly lighter than lithium batteries, enabling heavy-duty vehicles to maximize their payload. Further, while charging a lithium battery can take hours, onboard liquid hydrogen tanks can be filled within minutes, minimizing the downtime for the vehicles or equipment, and shortening the payback period. The production of green hydrogen via electrolysis using renewable electricity is being scaled in many countries. Thus, the use of renewable hydrogen is gaining traction across the globe in multiple aspects of our economy, including the transportation and industrial equipment sectors. Hydrogen fuel cells also have been proposed for use in powering buildings, material handling systems, and for providing emergency backup power.

Gaseous hydrogen for use as fuel can be stored in high pressure tanks, but gaseous hydrogen offers low volumetric capacity, even when stored at high pressures. This is problematic for use on vehicles and any other applications in which there are limitations on the size of the hydrogen storage tank. Liquefied hydrogen has a density of about 70 g/l and therefore offers the advantages of high volumetric capacity. Such systems are being developed for use on vehicles such as trucks and ships, and other applications in which there are limitations on the size of the hydrogen storage tank. The use of liquefied hydrogen, however, presents the challenge of boil-off losses. Owing to hydrogen's ultra-low boiling point (20° K), loss of vaporized hydrogen occurs all along the liquid hydrogen supply chain and during any extended storage period.

Accordingly, it is an object of the disclosure to provide a liquefied gas storage system in which boil-off of a liquefied low boiling point gas is captured and stored on an adsorbent to be desorbed for later use.

It is another object of the disclosure to provide a liquid hydrogen system in which boil-off hydrogen is captured and stored on an adsorbent to be desorbed for later use.

It is further an object of the disclosure to provide a liquid hydrogen system that is a fuel system in which boil-off hydrogen is captured and stored on an adsorbent and then desorbed from the adsorbent for use in the system, which system is suitable for use on a transportation vehicle, with a building, or with industrial equipment.

### SUMMARY

The foregoing objects are met by a liquefied gas system for capturing boil-off gas and reversibly adsorbing the boil-off gas on an adsorbent for later desorption and use, the system comprising
a liquefied gas vessel for storing liquefied gas,
a means for delivering gas from the liquefied gas vessel to a system endpoint,
an adsorbent vessel containing at least one adsorbent for reversibly adsorbing and storing boil-off gas emitted from the liquefied gas vessel,
a means for delivering boil-off gas from the liquefied gas vessel to the adsorbent vessel, whereby the boil-off gas is reversibly stored on the at least one adsorbent, and
a means for delivering the stored boil-off gas from the adsorbent vessel to the system endpoint.

In one embodiment the liquefied gas is liquefied hydrogen, and the system is a liquid hydrogen system for capturing boil-off hydrogen and reversibly adsorbing the boil-off hydrogen on an adsorbent for later desorption and use, the system comprising
a liquid hydrogen vessel for storing liquid hydrogen,
a means for delivering hydrogen from the liquid hydrogen vessel to a system endpoint,
an adsorbent vessel containing at least one adsorbent for reversibly adsorbing and storing boil-off hydrogen emitted from the liquid hydrogen vessel,
a means for delivering boil-off hydrogen from the liquid hydrogen vessel to the adsorbent vessel, whereby the boil-off hydrogen is reversibly stored on the at least one adsorbent, and
a means for delivering the stored boil-off hydrogen from the adsorbent vessel to the system endpoint.

Advantageously, the presence of the adsorbent in the adsorbent vessel increases the hydrogen storage capacity of that vessel to capture boil-off hydrogen from the liquid hydrogen storage vessel. As a further advantage, the adsorbent vessel does not need to operate at elevated pressures or at temperatures below the critical temperature of the gas.

In one embodiment the liquid hydrogen system endpoint is a hydrogen fuel-consuming power unit and the liquid hydrogen system provides hydrogen to the hydrogen fuel-consuming power unit. In one embodiment the power unit can be used to operate a transportation unit or an industrial machine. In one embodiment the transportation unit can be selected from a motor vehicle, a train, a marine vessel, or an aircraft; advantageously the liquid hydrogen system as disclosed herein can be used on board the transportation unit. In one embodiment the industrial machine can be selected from a machine used in farming, mining, construction, or manufacturing, and in some embodiments the liquid hydrogen system can be moved as the machine is moved from one location to another.

In one embodiment the liquid hydrogen system is used with a stationary hydrogen fuel system, such as for use in providing power to a building or other stationary structure.

In one embodiment the liquid hydrogen system is a hydrogen refueling system for supplying liquid hydrogen from a liquid hydrogen reservoir to a liquid hydrogen fuel system, and the endpoint of the liquid hydrogen system is the vessel for storing liquid hydrogen in the hydrogen fuel system. Such a refueling system comprises a reservoir for storing liquid hydrogen; a means for transferring liquid hydrogen from the reservoir to the liquid hydrogen storage vessel of a hydrogen fuel system; an adsorbent vessel for adsorbing and storing boil-off hydrogen from the reservoir, the adsorbent vessel containing at least one adsorbent whereby the boil-off hydrogen is reversibly adsorbed on the adsorbent; and a means for desorbing the adsorbed boil-off hydrogen and delivering it either to a liquid hydrogen vessel of a hydrogen fuel system or back to the liquid hydrogen reservoir.

In one embodiment the adsorbent has a pore volume of at least 0.5 cc/g, or at least 1 cc/g. In one embodiment the adsorbent has an adsorption capacity for hydrogen of at least 5 wt % at 60° K and 10 bar. In one embodiment the adsorbent comprises a material selected from one or more of a metal organic framework, a porous activated carbon, a covalent organic framework, a porous organic polymer, a zeolite, and combinations or mixtures of any of the foregoing. When more than one adsorbent is used, the adsorbents can be configured in the adsorbent vessel in radial layers, stacked layers, mixtures, or other configurations.

Also disclosed herein is a method of capturing boil-off gas from a liquefied gas system comprising a liquefied gas storage vessel, the method comprising providing an adsorbent vessel containing an adsorbent that reversibly adsorbs the gas; directing boil-off gas from the liquefied gas storage vessel to the adsorbent vessel; and directing the desorbed boil-off gas from the adsorbent vessel to a system end-point. In one embodiment the liquefied gas is liquid hydrogen.

### DESCRIPTION OF THE FIGURES

FIG. 1 is a schematic drawing of an embodiment of a liquefied gas boil-off recapture system of the disclosure wherein the liquefied gas is hydrogen.

FIG. 2 is a schematic drawing of an alternative embodiment of a liquid hydrogen boil-off recapture system, comprising multiple adsorbent beds.

FIG. 3 illustrates the mode of operation when the power unit is turned off or is idling.

FIG. 4 illustrates the mode of operation when the liquid hydrogen vessel is being filled from an external liquid hydrogen reservoir.

FIG. 5 illustrates the mode of operation when the power unit is turned on and drawing gaseous hydrogen from the liquid hydrogen vessel.

FIG. 6 illustrates the mode of operation when the power unit is turned on and drawing gaseous hydrogen from the liquid hydrogen vessel, while the adsorbent bed is being regenerated.

FIG. 7 illustrates the mode of operation when the system is operated to provide a cold flush of the adsorbent bed.

FIG. 8 illustrates an embodiment in which external cooling is provided to the adsorbent vessel when the power unit is turned on.

FIG. 9 illustrates an embodiment in which internal cooling is provided to the adsorbent bed when the power unit is turned on.

### DETAILED DESCRIPTION

Disclosed herein is a liquefied gas system for capturing boil-off gas from a source of liquefied gas, wherein the boil-off gas is reversibly adsorbed on an adsorbent for later desorption and use, the system comprising
a liquefied gas vessel for storing liquefied gas,
a means for delivering gas from the liquefied gas vessel to a system endpoint,
an adsorbent vessel containing at least one adsorbent for reversibly adsorbing and storing boil-off gas emitted from the liquefied gas vessel,
a means for delivering boil-off gas from the liquefied gas vessel to the adsorbent vessel, whereby the boil-off gas is reversibly stored on the at least one adsorbent, and
a means for delivering the stored boil-off gas from the adsorbent vessel to the system endpoint.

More specifically, disclosed herein is a liquid hydrogen system for capturing hydrogen boil-off from a liquid hydrogen storage vessel, the system comprising
a. a liquid hydrogen vessel for storing liquid hydrogen;
b. a means for delivering hydrogen from said liquid hydrogen vessel to a system end-point;
c. an adsorbent vessel containing at least one adsorbent for reversibly adsorbing and storing boil-off hydrogen emitted from the liquid hydrogen vessel;
d. a means for delivering boil-off hydrogen from the liquid hydrogen vessel to the adsorbent vessel, whereby the boil-off hydrogen is reversibly stored on the at least one adsorbent; and
e. a means for delivering the stored boil-off hydrogen from the adsorbent vessel to the system end-point.

The liquid hydrogen boil-off capture system can be used in connection with a hydrogen fuel-consuming power system, such as may be used with a transportation unit or hydrogen-powered machinery. The liquid hydrogen boil-off capture system also can be used with a hydrogen refueling system for supplying liquid hydrogen from a reservoir to a hydrogen storage vessel of a hydrogen fuel-consuming power system.

In one embodiment the system captures hydrogen boil-off when the rate of hydrogen boil-off from the liquid hydrogen vessel is greater than the rate of hydrogen delivery from the liquid hydrogen vessel to the system end-point.

In the illustrated embodiments herein the boil-off capture system is used with a hydrogen fuel-consuming power system used to power a transportation unit, such as a freight truck or other heavy-duty motor vehicle. It is to be understood that this embodiment is for illustrative purposes only, and the scope of the disclosure is not necessarily so limited.

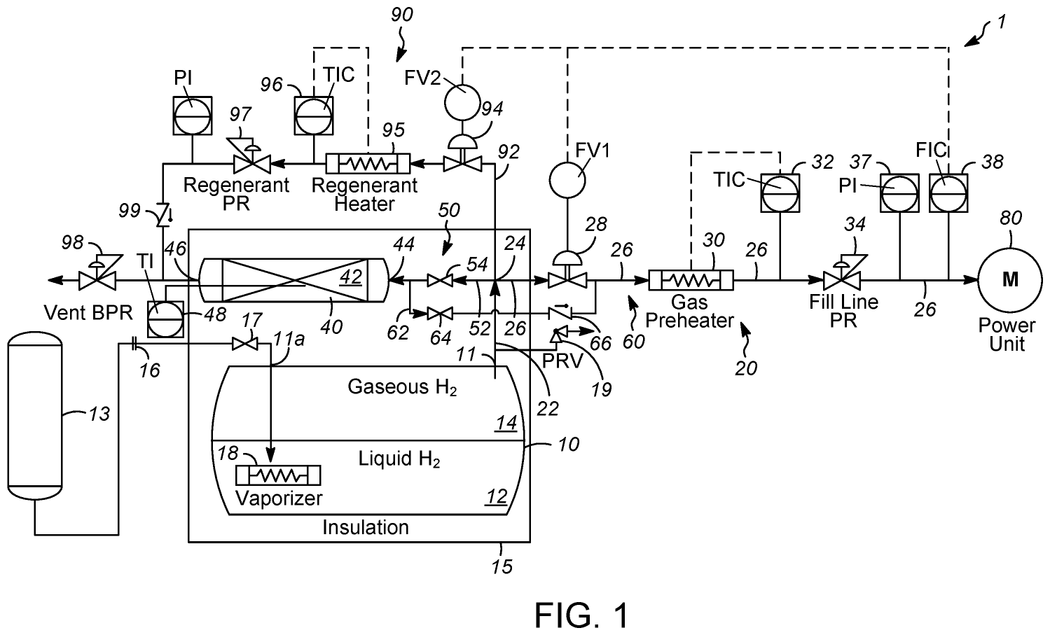

Referring to FIG. 1, liquid hydrogen boil-off capture system 1 comprises liquid hydrogen vessel 10 for storing liquid hydrogen, a system endpoint which in this illustrated embodiment is a hydrogen fuel-consuming power unit 80 such as a hydrogen fuel cell, a means 20 for delivering hydrogen from liquid hydrogen storage vessel 10 to power unit 80, an adsorbent vessel 40 for storing boil-off hydrogen emitted from liquid hydrogen storage vessel 10, a means 50 for delivering boil-off hydrogen from liquid hydrogen storage vessel 10 to adsorbent storage vessel 40, and a means 60 for delivering stored boil-off hydrogen from adsorbent storage vessel 40 to power unit 80. In one embodiment the boil-off capture system includes an optional regenerant system 90 for regenerating the at least one adsorbent. The individual components of the hydrogen boil-off capture system 1 that are operated electronically can be controlled by a programmable control module, not shown. The electronically operated components that are controlled by the programmable control module can include without limitation any one or more of vaporizers, heaters, pumps, valves, pressure indicators, pressure regulators, back pressure regulators, temperature indicators, temperature controllers, and flow controllers.

Liquid hydrogen storage vessel 10 contains liquid hydrogen 12 and a volume of gaseous hydrogen 14 above the top surface of liquid hydrogen 12. Liquid hydrogen storage vessel 10 is provided with insulation 15 to maintain the liquid hydrogen 12 at a temperature below 20° K. Liquid hydrogen storage vessel 10 can be provided with a vaporizer 18 to convert liquid hydrogen 12 to gaseous hydrogen 14 as may be desired to meet the demands of power unit 80. Liquid hydrogen storage vessel includes an opening 11 for release of gaseous hydrogen through conduit 22. Conduit 22 can be fitted with a pressure relief valve 19 sized to release gaseous hydrogen from liquid hydrogen storage vessel 10 in an over-pressuring event.

Liquid hydrogen storage vessel 10 can be filled from a separate liquid hydrogen filling system, not mounted on the transportation unit. The liquid hydrogen filling system can comprise external liquid hydrogen reservoir 13, conduit 16, and control valve 17. In one embodiment (not shown), conduit 16 can be removably connected to opening 11 to fill liquid hydrogen storage vessel 10. In another embodiment as illustrated in FIG. 1, conduit 16 can be removably connected to a separate opening 11 a which can serve as an inlet for liquid hydrogen.

Referring to FIG. 1, means 20 for delivering gaseous hydrogen from liquid hydrogen storage vessel 10 to power unit 80 comprises conduit 22 which extends from opening 11 of liquid hydrogen storage vessel 10; juncture 24; conduit 26 which extends from juncture 24 to power unit 80, and flow control valve 28 which controls the flow of hydrogen through conduit 26. In various embodiments, means 20 can further comprise any one or more of hydrogen gas pre-heater 30; temperature controller 32, pressure regulator 34, pressure indicator 37, and flow controller 38. When flow control valve 28 is open, gaseous hydrogen 14 can flow from liquid hydrogen vessel 10 to gas pre-heater 30 which is controlled by temperature controller 32 to heat the gaseous hydrogen to a temperature suitable for use by power unit 80. Gaseous hydrogen at the desired temperature then can continue through conduit 26 to pressure regulator 34 and on to power unit 80. Before entering power unit 80, the hydrogen pressure in conduit 26 is monitored by pressure indicator 37, and the flow rate is controlled by flow controller 38.

Adsorbent storage vessel 40 preferably is located externally of liquid hydrogen storage vessel 10. Adsorbent storage vessel 40 contains a bed 42 of at least one adsorbent capable of adsorbing gaseous hydrogen, as described more fully below. Adsorbent storage vessel 40 is provided with an opening 44 and an opening 46. Preferably, adsorbent storage vessel 40 is maintained at atmospheric pressure or above. Advantageously, maintaining the pressure in adsorbent vessel 40 at above atmospheric pressure will prevent atmospheric oxygen from leaking into the adsorbent vessel. Optionally, the temperature within adsorbent storage vessel 40 can be monitored by temperature indicator 48.

Means 50 for transferring boil-off hydrogen from liquid hydrogen storage vessel 10 to adsorbent storage vessel 40 comprises conduit 52 which extends from juncture 24 to opening 44 of adsorbent storage vessel 40. In one embodiment, means 50 can further comprise valve 54 which controls the flow of boil-off hydrogen through conduit 52.

In addition to insulation 15 around liquid hydrogen storage vessel 10, optionally insulation can be provided around adsorbent storage vessel 40, and the conduits and valves providing inflow and outflow from these vessels. In the illustrated embodiment, liquid hydrogen storage vessel 10 and adsorbent storage vessel 40 are located in sufficiently close proximity to each other such that both vessels can be disposed within the same system of insulation 15 to minimize warming of adsorbent storage vessel 40. Otherwise, two or more separate insulation systems can be provided for liquid hydrogen storage vessel 10 and adsorbent vessel 40, depending on the configuration of these components in liquid hydrogen system 1.

Means 60 for delivering desorbed boil-off hydrogen from adsorbent storage vessel 40 to power unit 80 comprises conduit 62 which extends from conduit 44 to conduit 26. In one embodiment, means 60 further comprises valve 64 and check valve 66 such that desorbed hydrogen gas flows through conduit 62, valve 64 and check valve 66 from which conduit 62 joins conduit 26 leading ultimately to power unit 80.

When adsorbent bed 42 in adsorbent vessel 40 is saturated with boil-off hydrogen from liquid hydrogen storage vessel 10, the bed can be regenerated by desorbing the hydrogen adsorbed therein. In one embodiment, hydrogen can be desorbed from bed 42 and drawn through opening 44 by applying a negative pressure at opening 44 by means such as a pump, not shown. The desorbed hydrogen can then be directed through means 60 to be delivered to power unit 80.

Optional regenerant system 90 for regenerating adsorbent bed 42 comprises conduit 92 which leads from juncture 24; flow control valve 94; regenerant heater 95, the temperature of which is controlled by temperature controller 96; and regenerant pressure regulator 97. In some embodiments check valve 99 and back pressure regulator 98 also can be included in regenerant system 90. Hydrogen from regenerant heater 95 is directed into opening 46 of adsorbent storage vessel 40. Pressure of the adsorbent storage vessel 40 is maintained at below a desired level by back pressure regulator 98; in one embodiment the back pressure regulator 98 will vent hydrogen when the pressure within adsorbent storage vessel 40 exceeds 10 bar.

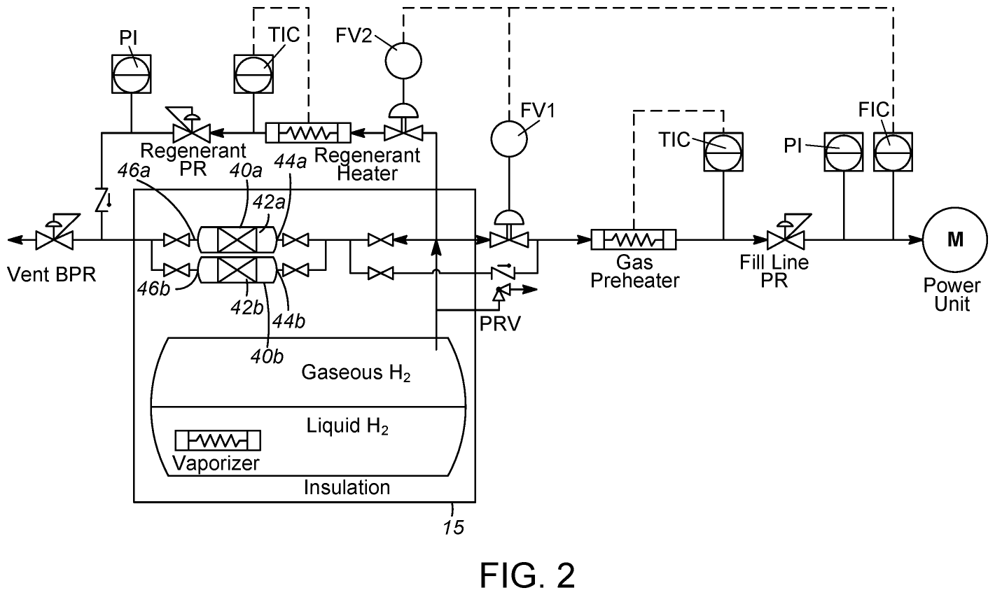

FIG. 2 illustrates an embodiment comprising two adsorbent storage vessels 40a and 40b each containing an adsorbent bed, 42a and 42b of at least one adsorbent capable of adsorbing gaseous hydrogen, and each having two openings 44a, 44b, and 46a, 46b. The adsorbents in the two beds can be the same or different. As illustrated the two adsorbent storage vessels are connected in parallel. In various embodiments more than two adsorbent vessels can be used, and the two or more adsorbent vessels can be connected in series, in parallel, or in any combination, depending on the application of the liquid hydrogen boil-off capture system. For the sake of simplicity, the following descriptions of various modes of operation are explained with respect to a system having a single adsorbent bed; however, each of the modes of operation can also be performed with systems having two or more adsorbent beds.

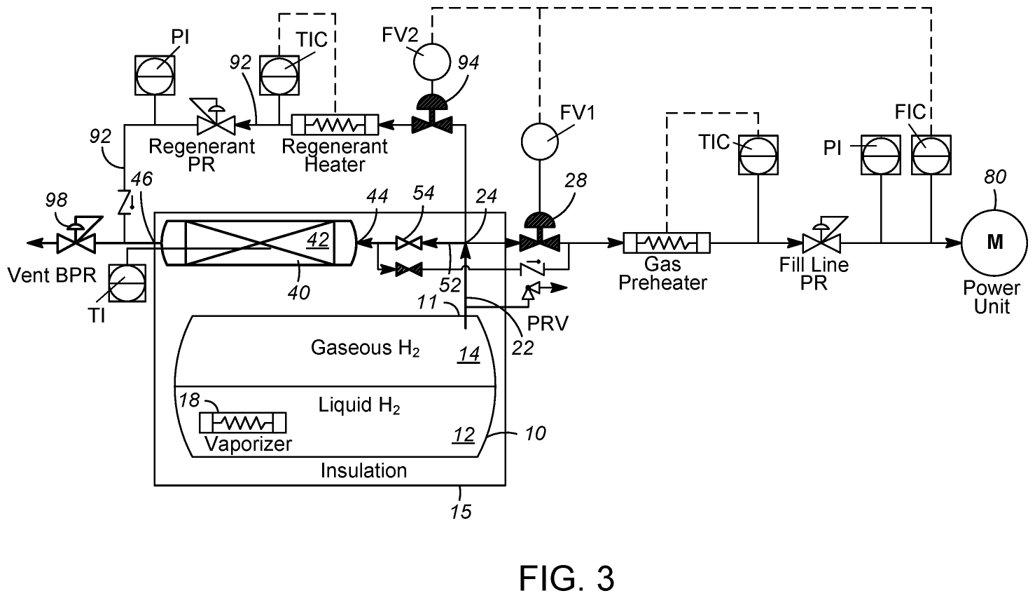

FIG. 3 illustrates the mode of operation when power unit 80 is not drawing hydrogen from liquid hydrogen storage vessel 10, such as when power unit 80 is turned off, or is idling. In this mode vaporizer 18 also may be powered off. When hydrogen is not being actively withdrawn from liquid hydrogen storage vessel 10 by operation of power unit 80, then gaseous hydrogen 14 may accumulate above liquid hydrogen 12. Gaseous hydrogen is allowed to escape the liquid hydrogen storage vessel 10 through opening 11 into conduit 22. Flow control valve 28 and flow control valve 94 are closed and valve 54 is open, such that the boil-off gaseous hydrogen is directed via valve 54 through conduit 52 and then into opening 44 of adsorbent storage vessel 40 where it is reversibly adsorbed onto the at least one adsorbent of bed 42. Back pressure regulator 98 can vent off excess boil-off gaseous hydrogen to maintain adsorbent storage vessel 40 pressure at a desired pressure level.

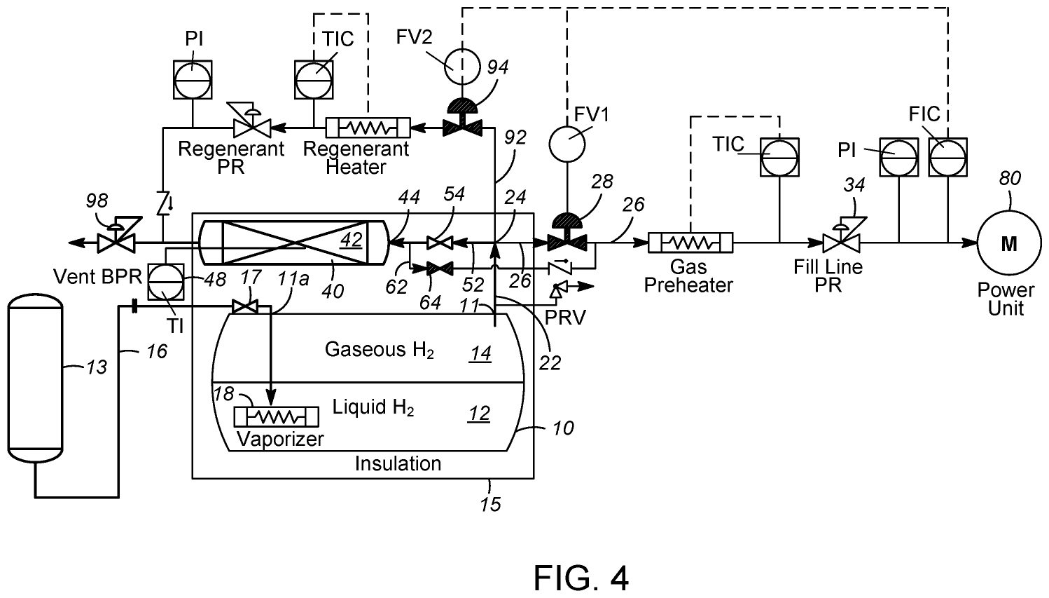

FIG. 4 illustrates the mode of operation when liquid hydrogen storage vessel 10 is being refilled with liquid hydrogen from external liquid hydrogen reservoir 13 through conduit 16 controlled by valve 17 to inlet 11a. Valves 28, 64 and 94 are all closed, and valve 54 is open. When refilling occurs, any gaseous hydrogen 14 in liquid hydrogen vessel 10 may experience increased pressure. This pressurized gaseous hydrogen 14 can be discharged through opening 11 into conduit 22, and then be directed via open valve 54 through conduit 52 and into opening 44 of adsorbent storage vessel 40 where it can be reversibly adsorbed onto the at least one adsorbent of bed 42. Any excess hydrogen gas can be vented through back pressure release valve 98.

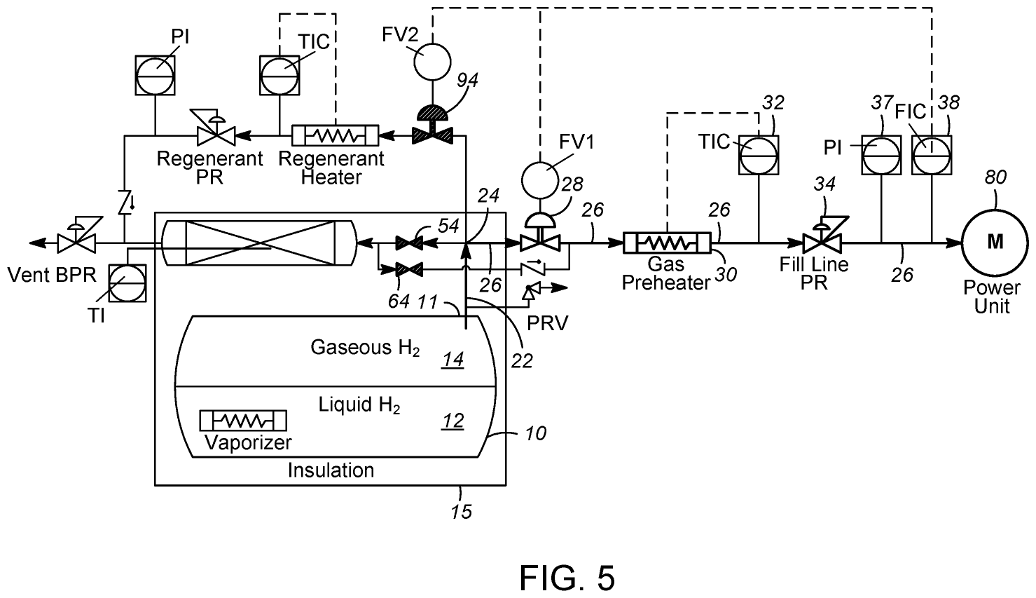

FIG. 5 illustrates the mode of operation when power unit 80 is in normal operation and drawing gaseous hydrogen 14 from liquid hydrogen storage vessel 10. Vaporizer 18 may be powered on as needed to generate sufficient gaseous hydrogen 14 from the liquid hydrogen 12. In this mode, valve 54, valve 64 and flow control valve 94 are each closed and flow control valve 28 is open, such that gaseous hydrogen 14 flows through opening 11 of liquid hydrogen storage vessel 10 into conduit 22, through juncture 24 into conduit 26, through gas pre-heater 30 which is controlled by temperature controller 32, then through pressure regulator 34 and on to power unit 80.

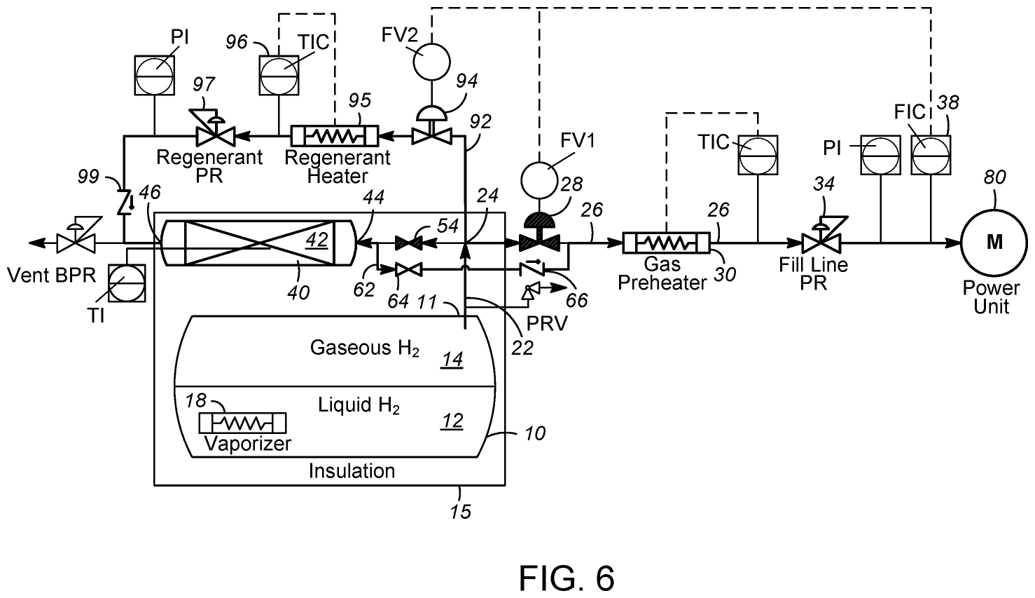

FIG. 6 illustrates the mode of operation in which power unit 80 is in operation and drawing hydrogen from adsorbent storage vessel 40, while simultaneously adsorbent bed 42 is regenerated with warmer hydrogen gas. Flow control valve 94 and flow control valve 28 are slowly opened and closed in cooperative relationship to provide a desired combined flow rate of gaseous hydrogen from liquid hydrogen vessel 10 and adsorbent vessel 40 to gas preheater 30 and then to power unit 80. More particularly, valve 54 leading into adsorbent bed 42 is closed and flow control valve 94 leading to regenerant heater 95 is slowly ramped open. Flow controller 38 slowly closes flow control valve 28 to maintain the gaseous hydrogen flow rate to power unit 80. Within liquid hydrogen storage vessel 10, vaporizer 18 is optionally operational to vaporize some of liquid hydrogen 12 to ensure an adequate flow of gaseous hydrogen 14 through opening 11. Gaseous hydrogen flows through opening 11 into conduit 22, past juncture 24 and into conduit 92. Open flow control valve 94 allows the gaseous hydrogen to pass through regenerant heater 95 controlled by temperature controller 96 which senses the temperature of gas exiting regenerant heater 95. The warmed hydrogen gas then flows through regenerant pressure regulator 97, through check valve 99, and through opening 46 into adsorbent storage vessel 40. The temperature of the warmed hydrogen gas that exits from regenerant heater 95 will be warm enough to warm adsorbent bed 42 to a desired regenerating temperature, generally about 80° K. The warmed hydrogen gas, along with hydrogen gas that is desorbed from adsorbent bed 42, then flows through opening 44 into conduit 62, through valve 64 and check valve 66, and then into conduit 26, where it follows the same path to power unit 80 as described with respect to the flow from liquid hydrogen storage vessel 10 as illustrated in FIG. 4.

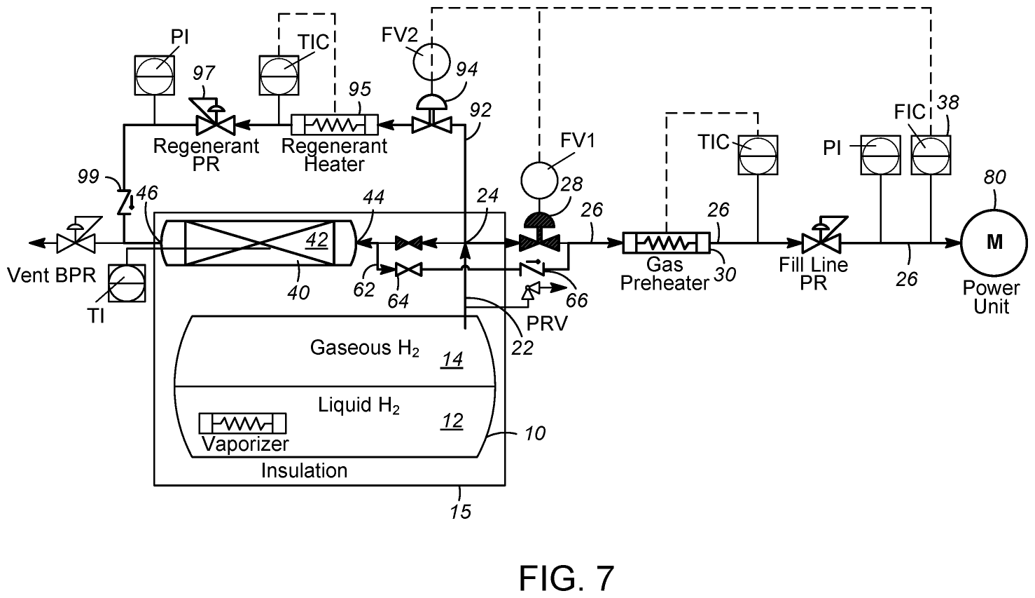

FIG. 7 illustrates a mode of operation in which the liquid hydrogen system is operated to provide a cold flush of adsorbent bed 42 to optimize adsorption of hydrogen on bed 42. To provide a cold flush, the system can be operated as described above with respect to FIG. 6 in which hydrogen gas 14 flows from liquid hydrogen storage vessel 10 through regenerant heater 95 to adsorbent storage vessel 40, except that regenerative heater 95 is turned off, so that hydrogen gas 14 entering adsorbent vessel 40 through opening 46 is unheated. This allows for a cold flush of adsorbent bed 42. The flushing hydrogen gas exits adsorbent storage vessel 40 slightly warmer than it was at the point of entry, then continues on the path through conduit 44, conduit 62, valve 64, check valve 66, to conduit 26, and on to power unit 80. The gas can be warmed by gas preheater 30 as may be necessary or desired before it reaches power unit 80.

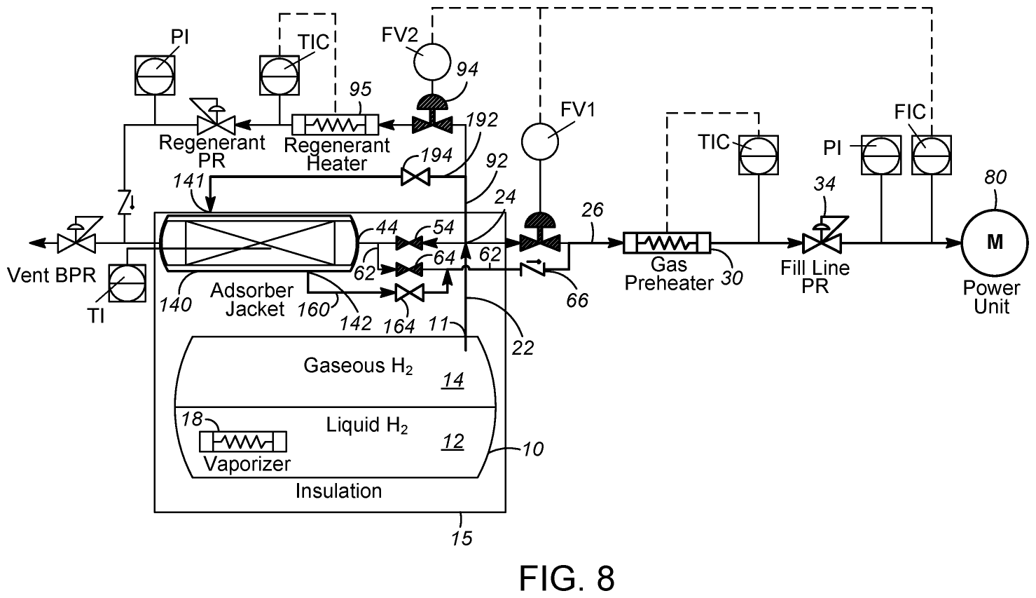

FIG. 8 illustrates an embodiment of the liquid hydrogen system in which external cooling of adsorbent vessel 40 is provided by means of a jacket 140, the jacket being provided with inlet 141 and outlet 142. Hydrogen gas 14 from liquid hydrogen storage vessel 10 travels through opening 11, through conduit 22, through juncture 24 and into conduit 92. Valve 94 is closed and valve 194 is open, such that the gas is directed through conduit 192 to jacket inlet 141. The gas circulates through jacket 140 to provide external cooling of adsorbent vessel 40 and exits at outlet 142 at a slightly warmer temperature than when it entered. From there it continues through conduit 160 and valve 164, where it enters conduit 62 downstream of closed valve 64, and then continues through check valve 66 into conduit 26, through gas preheater 30 and pressure regulator 34 onward to power unit 80.

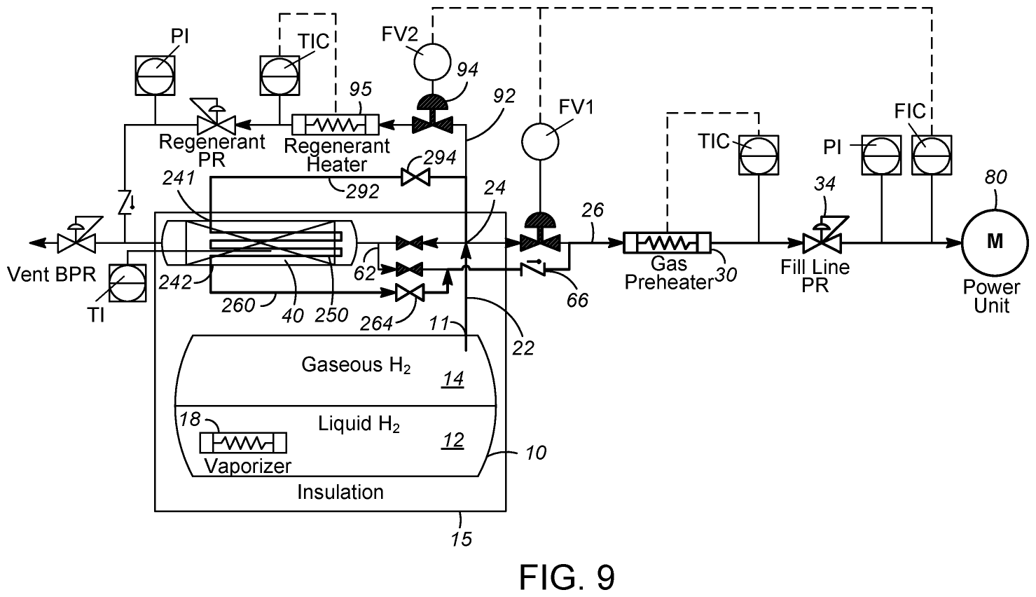

FIG. 9 illustrates an embodiment of the liquid hydrogen system in which internal cooling is provided to adsorbent vessel 40 by means of an internal heat exchanger 250, the inlet of which is connected to opening 241 of adsorbent vessel 40 and the outlet of which is connected to opening 242 of adsorbent vessel 40. Hydrogen gas 14 from liquid hydrogen storage vessel 10 travels through opening 11, through conduit 22, through juncture 24 and into conduit 92. Valve 94 is closed and valve 294 is open, such that the gas is directed through conduit 292 to opening 241 and into heat exchanger 250. In the illustrated embodiment the heat exchanger 250 is in the form of coiled conduit arranged in adsorbent bed 42 to optimize contact between the bed and the heat exchanger; other heat exchanger designs and arrangements will be understood by those skilled in the art. The gas that enters heat exchanger 250 is cooler than adsorbent bed 42, such that adsorbent bed 42 is cooled by the gas and the gas removes some heat from adsorbent bed 42. The heat exchanger 250 is joined at opening 242 to conduit 260, such that the gas continues from heat exchanger 250 through conduit 260, through valve 264 and into conduit 62, and then continues through check valve 66 into conduit 26, through gas preheater 30 and pressure regulator 34 onward to power unit 80.

It will be understood that the various features of the different embodiments as disclosed herein can be used in any combination. For example, it is within the concept of the disclosure to provide a hydrogen boil-off capture system that has an adsorber bed with no cooling, or with external cooling as illustrated in FIG. 7, or with internal cooling, or with both internal and external cooling. In addition, where multiple beds are used as illustrated in FIG. 2, any one or more beds can be provided with no cooling, internal cooling, external cooling, or both internal and external cooling.

In the illustrated embodiment the system is portable and end point 80 is a power unit that consumes hydrogen to generate power such as for a hydrogen powered freight truck. The disclosed system can be used anywhere a mobile liquid hydrogen system is used. The liquid hydrogen system with hydrogen boil-off capture as disclosed herein can be used on any means of transportation such as a motor vehicle, a train, a water craft, and an aircraft, and the boil-off capture system is on board the means of transportation along with the associated power unit. In one embodiment the liquid hydrogen system can be used to power an industrial machine, such as a machine used in farming, mining, construction, or manufacturing, and in some embodiments the liquid hydrogen system can be moved as the machine is moved from one location to another. It will be appreciated, however, that in alternative embodiments the power unit 80 can be a power unit of a stationary liquid hydrogen fuel system such as may be used to provide power to a building or other stationary structure. In other embodiments, the system is not part of a power generating system but is instead part of a liquid hydrogen transfer system. Then end point 80 is not a power unit but is connected to a liquid hydrogen storage vessel such as for use with a power-generating system.

The adsorbent which can be used comprises any number of adsorbents which are characterized by a B.E.T. surface area of at least 200 m²/g or at least 400 m²/g or at least 600 m²/g, or at least 1000 m²/g or at least 5000 m²/g, or at least 8000 m²/g or at least 10,000 m²/g. In a particular aspect, the surface area is from about 200 m²/g to about 10,000 m²/g. Also suitable are those adsorbents having a pore volume of at least 0.5 cc/g, or at least 1 cc/g. In one embodiment the adsorbent has an adsorption capacity for hydrogen of 5 wt % at 60° K and 10 bar. General categories of adsorbents which have this property and can be used in the invention include without limitation metal organic framework materials (MOFs), zeolites, activated carbon, covalent organic frameworks (COFs), porous organic polymers (POPs) and mixtures thereof.

MOFs are well known porous adsorbents with high surface areas. MOF adsorbents comprise metal ion corner atoms and an at least bidentate linker molecule or a ligand, which is connected to the corner atom(s) thereby forming a framework structure. The metal ions which can be used include but are not limited to Li⁺, Na⁺, K⁺, Rb⁺, Be²⁺, Mg²⁺, Ca²⁺, Sr²⁺, Ba²⁺, Sc³⁺, Y³⁺, Ti⁴⁺, Zr⁴⁺, Hf⁴⁺, V⁵⁺, V⁴⁺, V³⁺, Nb³⁺, Ta³⁺, Cr³⁺, Cr²⁺, Mo³⁺, W³⁺, Mn³⁺, Fe³⁺, Fe²⁺, Ru³⁺, Ru²⁺, Os³⁺, Os²⁺, Co³⁺, Co²⁺, Ni²⁺, Ni⁺, pd²⁺, pd⁺, pt²⁺, Pt⁺, Cu²⁺, Cu⁺, Ag⁺, Au⁺, Zn²⁺, Al³⁺, Ga³⁺, In³⁺, Si⁴⁺, Si²⁺, Ge⁴⁺, Ge²⁺, Sn⁴⁺, Sn²⁺, Bi⁵⁺, Bi³⁺, Cd²⁺, Mn²⁺, Tb³⁺, Gd³⁺, Ce³⁺, La³⁺, Cr⁴⁺, and mixtures thereof. A subgroup of the metal ions is selected from Ti⁴⁺, Zr⁴⁺, Hf⁴⁺, Fe³⁺, Fe²⁺, Co³⁺, Co²⁺, Ni²⁺, Ni⁺, Cu²⁺, Cu⁺, Zn²⁺, Ga³⁺, Al³⁺ and mixtures thereof. From this subgroup one subgroup of metal ions includes those selected from Ti⁴⁺, Zr⁴⁺, Fe³⁺, Co³⁺, Ni²⁺, Cu²⁺, Zn²⁺, Ga³⁺, Al³⁺ and mixtures thereof. Another subgroup of metal ions includes Fe³⁺, Cu²⁺, and Zn²⁺. Another subgroup of metal ions includes Ca²⁺, Cu²⁺, Zn²⁺, Fe³⁺, Fe²⁺, and Y³⁺. In one embodiment the metal ion is Ca²⁺; in one embodiment the metal ion is Cu²⁺; in one embodiment the metal ion is Zn²⁺; in one embodiment the metal ion is Fe³⁺; in one embodiment the metal ion is Fe²⁺; in one embodiment the metal ion is Y³⁺.

The metal ion corner atoms are joined by at least bidentate organic linker molecules comprising two or more sites capable of binding to a metal ion corner atom to form a metal organic framework structure. Optionally, at least bidentate inorganic linker molecules also can be used. The at least bidentate organic linker molecules include but are not limited to those having a saturated or unsaturated alkyl or aryl backbone, optionally comprising one or more heteroatoms S, N, O, or P, and optionally comprising one or more functional groups bonded to the backbone. In certain embodiments the linker backbone can comprise one or more groups selected from 1) saturated or unsaturated, linear, branched or cyclic alkyl groups having from 1 to 10 carbon atoms and optionally comprising heteroatoms; and 2) groups comprising 1 to 5 aryl or heteroaryl rings which can be fused or joined covalently; wherein the hetero atoms are selected from S, N, O, P and mixtures thereof. The backbones of the linker molecules may have bonded thereto one or more functional groups, including but not limited to saturated and unsaturated alkyl, aryl, heteroaryl, halide, —OH, —NH₂, —COOH, NO₂, COH, CO(NH₂), CN and thiols. In one embodiment the functional groups are selected from COOH and NH₂.

Silicon halides such as SiF₆ also may be used as linkers in the framework structure.

A subgroup of these ligands includes substituted or unsubstituted, mono- or polynuclear aromatic di-, tri- and tetracarboxylic acids and unsubstituted or substituted, with at least one hetero atom, aromatic di-, tri- and tetracarboxylic acids. In one embodiment the ligands include without limitation 1,3,5-benzene tricarboxylic acid (BTC), triazine tris-benzoic acid (TATB), 2-amino-terephthalic acid, naphthalene dicarboxylate (NDC), acetylene dicarboxylate (ADC), benzene-1,4-dicarboxylic acid (BDC), benzene tribenzoate (BTB), methane tetrabenzoate (MTB), adamantane tetracarboxylate (ATC), adamantane tribenzoate (ATB), 4,4′,4″,4″′-(pyrene-1,3,6,8-tetrayl)tetrabenzoic acid (TBAPy), meso-Tetraphenylporphine-4,4′,4″,4″′-tetracarboxylic acid (TCPPH2), 3,3′,5,5′-azobenzenetetracarboxylic acid, 2,5-dihydroxyterephthalic acid, pyrazine, 1,4-diazabicyclo[2.2.2]octane, SiF₆, a ligand of the formula

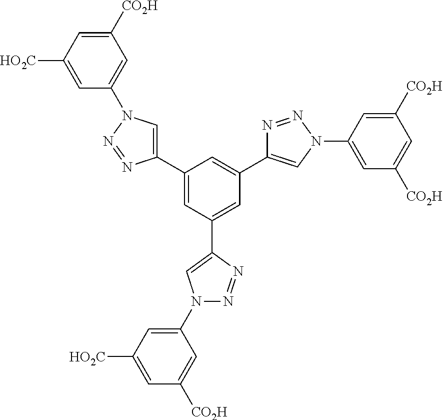 [SMILES: O=C(O)c1cc(C(=O)O)cc(-n2cc(-c3cc(-c4cn(-c5cc(C(=O)O)cc(C(=O)O)c5)nn4)cc(-c4cn(-c5cc(C(=O)O)cc(C(=O)O)c5)nn4)c3)nn2)c1]

which is 5,5′,5″-(4,4′,4″-(benzene-1,3,5-triyl)tris(1H-1,2,3-triazole-4,1-diyl))triisophthalic acid, and mixtures thereof. In one embodiment the ligands include without limitation terephthalic acid, azobenzene tetracarboxylic acid, trimesic acid, 1,4-diazabicyclo[2.2.2]octane, and the ligand of formula

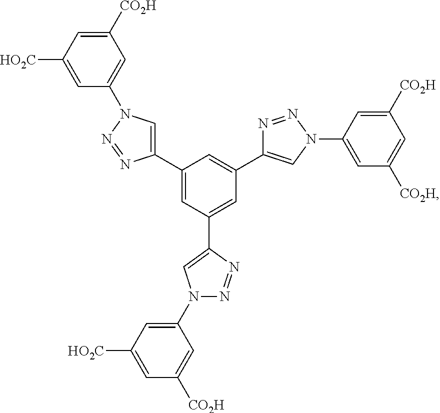 [SMILES: O=C(O)c1cc(C(=O)O)cc(-n2cc(-c3cc(-c4cn(-c5cc(C(=O)O)cc(C(=O)O)c5)nn4)cc(-c4cn(-c5cc(C(=O)O)cc(C(=O)O)c5)nn4)c3)nn2)c1]

and mixtures thereof. Other ligands that can be used include 4,4′-sulfonyldibenzoic acid, 1H,5H -benzo(1,2-d:4,5-d′)bistriazole, 7,7′,8,8′-tetracyanoquinodimethane, squaric acid, and azobenzene-4,4′-dicarboxylic acid.

Specific MOFs include without limitation MOF-5 which a MOF comprising Zn²⁺ and terephthalic acid; MIL-101 which is MOF comprising Fe³⁺ and terephthalic acid; NU-125 which is a MOF comprising Cu²⁺ and the ligand of formula

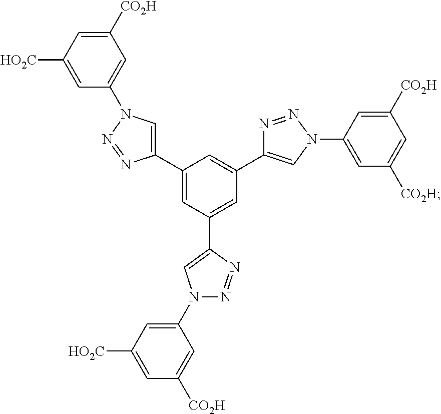 [SMILES: O=C(O)c1cc(C(=O)O)cc(-n2cc(-c3cc(-c4cn(-c5cc(C(=O)O)cc(C(=O)O)c5)nn4)cc(-c4cn(-c5cc(C(=O)O)cc(C(=O)O)c5)nn4)c3)nn2)c1]

PCN-250, which is a MOF comprising Fe³⁺ and azobenzene tetracarboxylic acid; HKUST-1, which is a MOF comprising Cu²⁺ and trimesic acid; MOF-177 which is a MOF comprising Zn²⁺ and the ligand benzene tribenzoate (BTB); Zn₂(BDC)₂(DABCO) which is a MOF comprising Zn²⁺, terephthalic acid, and 1,4-diazabicyclo[2.2.2]octane; SBMOF-1 which is a MOF comprising Ca²⁺ and 4,4′-sulfonyldibenzoic acid, MFU which is a MOF comprising Zn²⁺ and 1H,5H -benzo(1,2-d:4,5-d′)bistriazole; Cu(TCNQ) which is a MOF comprising Cu²⁺ and 7,7′,8,8′-tetracyanoquinodimethane; CaSquarate which is a MOF comprising Ca²⁺ and squaric acid; and Y-ABTC which is a MOF comprising Y3+ and azobenzene-4,4′-dicarboxylic acid; and mixtures thereof.

There are several ways to prepare MOF compositions but the most commonly used one is the solvothermal synthesis. For example, see Yujia Sun and Hong-Cai Zhou, Recent Progress in the Synthesis of Metal Organic Frameworks, Sci. Technol. Adv. Mater. 16 (2015), 054202 which is incorporated by reference. In this procedure a metal salt and the desired ligand/linker are dissolved in an appropriate solvent and reacted at an elevated temperature for a required time. Once the MOF is formed, the powder is isolated from the reaction mixture, washed, and dried.

Another adsorbent which can be used in the process of the invention is a zeolite. Zeolites are crystalline aluminosilicate compositions that are microporous and that are formed from corner sharing AlO₂ and SiO₂ tetrahedra. Numerous zeolites, both naturally occurring and synthetically prepared, can be used in the practice of the invention. Synthetic zeolites are prepared via hydrothermal synthesis employing suitable sources of Si, Al, and structure directing agents such as alkali metals, alkaline earth metals, amines, and/or organoammonium cations. The structure-directing agents reside in the pores of the zeolite and are largely responsible for the particular structure that is ultimately formed. These species balance the framework charge associated with aluminum and can also serve as space fillers. The naturally occurring zeolites include but are not limited to faujasite, analcime, chabazite, clinoptilolite, heulandite, natrolite, phillipsite, stilbite, mordenite, erionite, offretite, ferrierite and mixtures thereof. Of these, faujasite, chabazite, clinoptilolite, phillipsite, mordenite, erionite, offretite, ferrierite and mixtures thereof are of particular interest. Synthetic zeolites include without limitation zeolites A, B, X, Y, L, alpha, beta, omega, ZSM-5, silicalite, ZSM-11, MCM-22, ZK-4, EU-1, FU-1, NU-1, LZ-210 and mixtures thereof. Part or all of the silica in a zeolite can be substituted. For example, SAPO, ALPO, MeAPO, where Me is a metal selected from Li, Be, B, Mg, Mn, Si, Ti, Fe, Zn, Ga, Ge, As, and Cr. A review of the history of zeolites along with their structures and characteristics can be found in Studies in Surface Science and Catalysis, vol. 137, H. van Bekkum, E. M. Flanigen, P. A. Jacobs and J. C. Jansen (editors), 2001, Elsevier Science B.V. which is incorporated by reference.

Another adsorbent that can be used in the system is activated carbon. Activated carbon is a highly porous, high surface area adsorptive material with a largely amorphous structure. It is composed primarily of aromatic configurations of carbon atoms joined by random cross- linkages. The degree of order varies based on the starting raw material and thermal history. Graphitic platelets in steam-activated coal are somewhat ordered, while more amorphous aromatic structures are found in chemically activated wood. Randomized bonding creates a highly porous structure with numerous cracks, crevices and voids between the carbon layers. Activated carbon sorbents are tailored for specific applications mainly based on pore size and pore volume requirements. Porosity and other parameters are controlled by the following: 1) raw material selection; 2) activation process conditions; and 3) post-processing steps. Depending on the application, activated carbon may be in the form of powder (PAC), granule (GAC) or extrudate (EAC). All three forms are available in a range of particle sizes. A review of the fundamentals of activated carbon can be found in an article entitled: Activated Carbon: Fundamentals and New Applications, Ken Koehlert, Chemical Engineering, July 2017, pp. 32-40, which is incorporated by reference. One brand of activated carbon that may be suitable in the disclosed system is Maxsorb® high surface area activated carbon.

Porous organic polymers (POP) are the polymerization product from at least a plurality of organic monomers. POPs are generally constructed from monomer units that are multitopic (three or more connection points). While the degree of cross-linking in a microporous polymeric material depends on the concentration of cross-linking molecules added, cross-linking in POPs is dictated by the valency/topicity of the monomer or co-monomer unit(s). Cross-links in POPs, formed between rigid building blocks, are also different from those in polymer gels, which are usually formed between flexible chains and side chains. POPs are amorphous materials and their synthesis is well known in the art. For example, POPs can be synthesized from the reaction of: 1) catechol and aryl halides; 2) anhydride monomer and diamine monomer; and 3) carboxylic monomer and diamine monomer.

Covalent organic frameworks (COF) are a subset of POPs in that they are crystalline materials. Again, these materials and their synthesis are well known in the art.

Regardless of which type of adsorbent or combination of adsorbents is chosen, it is necessary that the adsorbent have pores from about 2 to about 500 angstroms, or from about 3 to about 500 angstroms, or from about 3 to about 200 angstroms, or from about 3 to about 100 angstroms, or from about 5 to about 200 angstroms, or from about 10 to about 200 angstroms, or from about 5 to about 100 angstroms or from about 10 to about 100 angstroms. Smaller pores increase the interaction between the adsorbents and the hydrogen molecules, thus facilitating the adsorption-based capture.

Although the various adsorbents can be used in the powder form, it may be advantageous to form the adsorbent into various shaped bodies such as pellets, spheres, disks, monolithic bodies, irregularly shaped particles and extrudates. The methods of forming these types of shapes are well known in the art. The adsorbent materials can be formed into various shapes by themselves or by including a binder. When selecting a binder, it is important to select a binder such that the surface area and adsorption capacity is not adversely affected once the desired shaped body is formed. Materials which can be used as binders include without limitation cellulose, silica, carbon, alumina, and mixtures thereof.

The forming process usually involves preparing a thick paste-like material by mixing the adsorbent composition with a solvent or a binder plus a solvent. Once the paste-like material is formed it can be extruded through a die having holes of about 1-2 mm to form extrudates of varying length, e.g. 6-10 mm. The paste or even the powder itself can be pressed at high pressure to form pellets or pills. Other means of forming shapes include pressure molding, metal forming, pelletizing, granulation, extrusion, rolling methods and marumerizing.

In yet another aspect of the invention, the adsorbent materials can be deposited onto articles such as, but not limited to, monoliths, spherical supports, ceramic foams, glass fibers, woven fabrics, nonwoven fabrics, membranes, pellets, extrudates, irregularly shaped particles, and mixtures thereof. When the desired article is a monolith, spherical support, ceramic foam, pellets, extrudates, or irregularly shaped particles, a slurry of the adsorbent composition is prepared and deposited on the article by means such as dipping, spray drying, etc. followed by drying and optionally calcination.

It is also within the scope of the invention that more than one type of adsorbent can be used to reversibly adsorb the hydrogen in the adsorbent bed. For example, two or more adsorbents can be mixed and formed into a bed. Alternatively, the adsorbents can be used as separate layers in a bed. In the case where the adsorbents are deposited onto fabrics, such as woven or non-woven fabrics, the adsorbents can be mixed and deposited as a mixture or deposited as separate layers on one fabric or deposited on separate fabrics and layered. If the adsorbents are formed into shapes such as pellets, spheres, extrudates, again two or more adsorbent powders can be combined and formed into such shapes. Alternatively, each adsorbent can be formed into a desired solid shaped article and then arranged in separate layers or the solid shaped articles mixed and then arranged in a bed or other configuration.

Also disclosed herein is a method of capturing boil-off hydrogen from a liquid hydrogen system, the method comprising providing a liquid hydrogen storage vessel; providing an adsorbent vessel containing an adsorbent that reversibly adsorbs gaseous hydrogen; directing boil-off hydrogen from the liquid hydrogen storage vessel to the adsorbent vessel; and directing the adsorbed boil-off hydrogen from the adsorbent vessel to a system end-point, substantially as illustrated herein.

In yet another embodiment the liquefied gas boil-off system is used with a gas other than hydrogen. For example, the boil-off system as disclosed herein can be used to capture boil-off gas from stored liquefied low-boiling gases, particularly the rare or noble gases such as argon (b.p. 87.3° K), xenon (b.p. 165° K), krypton (b.p. 119.7° K), neon (b.p. 27.1° K) and helium (b.p. 4° K). The adsorbed gas can be desorbed when desired and either returned to the liquefied gas storage vessel or directed to another system end point such as one to which gas from the liquefed gas storage vessel is directed. When the liquefied gas is either xenon or krypton, a suitable adsorbent can include SBMOF-1. When the liquefied gas is neon, a suitable adsorbent can include any one or more of MFU-4, Cu(TCNQ) CaSquarate, and Y-ABTC.

The foregoing description of embodiments of the liquefied gas boil-off capture system are presented by way of illustration and not by way of limitation. Those skilled in the art will recognize that many variations are possible within the spirit and scope of the disclosure, which is intended to be defined by the following claims and their equivalents in which all terms are meant in their broadest reasonable sense unless otherwise indicated.

What is claimed is:

1. A liquefied gas system for capturing gas boil-off from a liquefied gas storage vessel, the system comprising
a. a liquefied gas vessel for storing liquefied gas;
b. a means for delivering gas from said liquefied gas vessel to a system end-point;
c. an adsorbent vessel for storing boil-off gas emitted from said liquefied gas vessel, said adsorbent vessel containing at least one adsorbent;
d. a means for delivering boil-off gas from said liquefied gas vessel to said adsorbent vessel whereby said boil-off gas is reversibly stored on said at least one adsorbent; and
e. a means for delivering the stored boil-off gas from said adsorbent vessel to said system end-point.

2. The liquefied gas system of claim 1 in which said means for delivering boil-off gas from said liquefied gas vessel to said adsorbent vessel is in operation when the rate of gas boil-off from said liquefied gas vessel is greater than the rate of gas delivery from said liquefied gas vessel to said system end-point.

3. The liquefied gas system of claim 1 further comprising a regenerant system for regenerating said at least one adsorbent.

4. The liquefied gas system of claim 1 wherein said gas is hydrogen.

5. The liquefied gas system of claim 4 wherein said system end-point is a power unit.

6. The liquefied gas system of claim 5 wherein said power unit is for use on a transportation unit and said liquefied gas system is on board said transportation unit.

7. The liquefied gas system of claim 5 wherein said end point is a power unit of a stationary hydrogen fuel system.

8. The liquefied gas system of claim 4 wherein said liquefied gas vessel is a liquid hydrogen reservoir and the system end-point is a liquid hydrogen vessel of a liquid hydrogen system for providing hydrogen power.

9. The liquefied gas system of claim 5 wherein said power unit is for use to power a machine.

10. The liquefied gas system of claim 1 wherein said adsorbent has a pore volume of at least 0.5 cc/g, or at least 1 cc/g.

11. The liquefied gas system of claim 1 wherein said gas is selected from hydrogen, argon, xenon, krypton, neon and helium.

12. The liquefied gas system of claim 1 wherein said at least one adsorbent comprises a material selected from one or more of a metal organic framework, a porous activated carbon, a covalent organic framework, and a porous organic polymer.

13. The liquefied gas system of claim 12 wherein said metal organic framework comprises metal ion corner atoms connected by at least bidentate organic ligands to form a framework structure, wherein said metal ions are selected from Li⁺, Na⁺, K⁺, Rb⁺, Be²⁺, Mg²⁺, Ca²⁺, Sr²⁺, Ba²⁺, Sc³⁺, Y³⁺, Ti⁴⁺, Zr⁴⁺, Hf⁴⁺, V⁵⁺, V⁴⁺, V³⁺, Nb³⁺, Ta³⁺, Cr³⁺, Cr²⁺, Mo³⁺, W³⁺, Mn³⁺, Fe³⁺, Fe²⁺, Ru³⁺, Ru²⁺, Os³⁺, Os²⁺, Co³⁺, Co²⁺, Ni²⁺, Ni⁺, Pd²⁺, Pd⁺, Pt²⁺, Pt⁺, Cu²⁺, Cu⁺, Ag⁺, Au⁺, Zn²⁺, Al³⁺, Ga³⁺, In³⁺, Si⁴⁺, Si²⁺, Ge⁴⁺, Ge²⁺, Sn⁴⁺, Sn²⁺, Bi⁵⁺, Bi³⁺, Cd²⁺, Mn²⁺, Tb³⁺, Gd³⁺, Ce³⁺, La³⁺ and Cr⁴⁺, and mixtures thereof.

14. The liquefied gas system of claim 12 wherein said metal organic framework is selected from any one or more of MOF-5, MIL-101, NU-125, PCN 250, HKUST-1, MOF-177, Zn₂(BDC)₂(DABCO), SBMOF-1, MFU, Cu(TCNQ), CaSquarate, and Y-ABTC.

15. The liquefied gas system of claim 13 wherein the at least bidentate ligands are selected from 1,3,5-benzene tricarboxylic acid (BTC), triazine tris-benzoic acid (TATB), 2-amino-terephthalic acid, naphthalene dicarboxylate (NDC), acetylene dicarboxylate (ADC), benzene-1,4-dicarboxylic acid (BDC), benzene tribenzoate (BTB), methane tetrabenzoate (MTB), adamantane tetracarboxylate (ATC), adamantane tribenzoate (ATB), 4,4′,4″,4″′-(pyrene-1,3,6,8-tetrayl)tetrabenzoic acid (TBAPy), meso-Tetraphenylporphine-4,4′,4″,4″′-tetracarboxylic acid (TCPPH2), 3,3′,5,5′-azobenzenetetracarboxylic acid, 2,5-dihydroxyterephthalic acid, pyrazine, 1,4-diazabicyclo[2.2.2]octane, SiF₆, a ligand of the formula 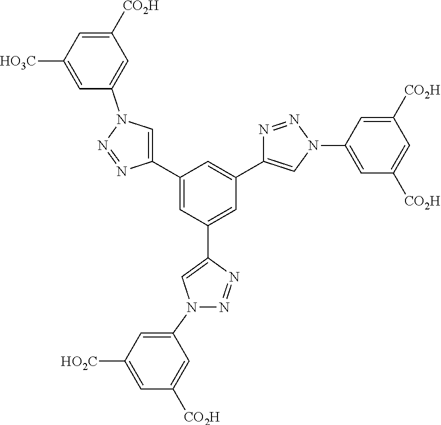
4,4′-sulfonyldibenzoic acid, 1H,5H-benzo(1,2-d:4,5-d′)bistriazole, 7,7′,8,8′-tetracyanoquinodimethane, squaric acid, azobenzene-4,4′-dicarboxylic acid, and mixtures thereof.

16. The liquefied gas system of claim 1 comprising more than one adsorbent vessel for storing boil-off hydrogen emitted from said liquid hydrogen vessel and containing at least one adsorbent.

17. The liquefied gas system of claim 1 wherein said adsorbent vessel is provided with an external cooling means.

18. The liquefied gas system of claim 1 wherein said adsorbent vessel is provided with an internal cooling means.

19. A method of capturing boil-off gas from a liquefied gas system comprising a liquefied gas storage vessel, the method comprising the steps of
a.) providing an adsorbent vessel containing an adsorbent that reversibly adsorbs boil-off gas from said storage vessel;
b.) directing boil-off gas from the liquefied gas storage vessel to the adsorbent vessel; and
c.) directing the adsorbed boil-off gas from the adsorbent vessel to a system end-point.

20. The method of claim 19 wherein said wherein said gas is selected from hydrogen, argon, xenon, krypton, neon and helium.
